(19) United States
(12) Patent Application Publication
(10) Pub. No.: US 2015/0353798 A1
(43) Pub. Date: Dec. 10, 2015

(54) COMPOSITION AND METHOD FOR TREATING CEMENT, CONCRETE, MORTAR OR FLOOR SCREED OR THE LIKE MATERIALS AND USE THEREOF

(71) Applicant: SHARK SOLUTTONS APS, Vipperød (DK)

(72) Inventor: Jens Holmegaard, Svinninge (DK)

(73) Assignee: Shark Solutions ApS, Vipperød (DK)

(21) Appl. No.: 14/763,211

(22) PCT Filed: Jan. 27, 2014
(86) PCT No.: PCT/DK2014/050015

§ 371 Date: Jul. 24, 2015

(30) Foreign Application Priority Data
Jan. 28, 2013 (EP) 13152869.7

(51) Int. Cl. C09K 3/22; C09D 129/14

(52) U.S. Cl. CPC C09K 3/22; C09D 129/14

(57) ABSTRACT

A method for treating surfaces of cement, concrete, mortar or floor screed or stone, marble or granite by applying at least one layer of a composition comprising of 2-20% by weight of particles of plasticized polyvinyl butyral (PVB) dispersed in water in an amount of 100 g/m²-600 g/m². This ensures that the surfaces exhibit improved resistance to wear and reduced creation of dust during wear, i.e., a dust binding effect is achieved and protects the surfaces from being stained. The application of the aqueous PVB dispersion provides improved adhesion of conventional top coatings, such as epoxy or polyurethane (PU) based resins and results in a brighter surface on the treated surfaces. A composition and uses are also disclosed.

### BACKGROUND OF THE INVENTION

1. Field of the Invention

The present invention relates to dust binder and/or primer composition for cement, concrete, mortar, floor screed, marble or granite or the like materials comprising dispersed particles of polyvinyl butyral (PVB).

2. Description of Related Art

In addition, the present invention relates to a method for treating surfaces thereof cement, concrete, mortar or floor screed or the like materials for improving abrasion resistance (binding dust) of such surfaces and use of a composition comprising dispersed particles of polyvinyl butyral (PVB) for treating surfaces of cement, concrete, mortar, floor screed or the like.

Surfaces of materials such as cement, concrete, mortar, floor screed , marble or granite or the like materials are sometimes left untreated in a building, e.g., in cellars, in car parking houses, storage facilities, workshops or in case the architect wishes to give the building (or parts thereof) an impression of a “raw” look. Such untreated surfaces are often stained by various materials e.g., oil, grease, coffee, paint etc. e.g., when dropped on the floor or splashed on a wall by accident. These stains are not easily removed. In addition, an untreated surface of cement, concrete, mortar, floor screed, marble or granite or the like materials are less resistant to wear and may then create dust of cement/concrete/mortar/floor screed/stone/granite/marble when the surface is subjected to wear.

Otherwise the surfaces may be coated with one or more layers of standard coatings for cement, concrete, mortar or floor screed or the like materials, such as coatings based on epoxy, polyurethane (PU) or the like in order to obtain surfaces which are more resistant to wear and staining. These prior art coatings are partly absorbed into cement, concrete, mortar or floor screed or the like materials and the treated surfaces of obtains a dark and sometimes even unpleasant look. Floor screed materials treated with a standard PU coating typically obtain a reduced tensile strength of the surface due to the elastic nature of PU based coatings.

Poly vinyl butyral (PVB) has been manufactured since the 1930 and is, since it is very expensive, mainly used as laminating material in non-shatterable automotive or architectural glass. PVB is non toxic and is not dissolvable in water, but is soluble in organic solvents such as alcohols, esters, ketones. PVB is an expensive material and use of PVB has thus been limited to special applications, e.g., as laminating material for non-shatterable glass or windshields. PVB used in wind shields and/or similar non-shatterable glass is recovered in a process in which glass is crushed and the laminate layer of PVB is separated from the glass.

The recycled PVB can be used as an additive in coatings, adhesives etc. on textiles, metals etc. or as a peelable flexible coating on various articles. For example, U.S. Pat. No. 4,792,464 discloses a peelable flexible an anti-corrosive coating for metal surfaces comprising an aqueous PVB dispersion having 20-50% by weight of PVB and contains plasticizer in an amount of 20-30% by weight of the solids.

Soviet Union application SU 1454813 discloses a composition for impregnating concrete, which contains PVB in combination with other polymers: an epoxide resin, polyethylene poly-amine, poly-alumino-organo-siloxane, polyvinyl butyral and unsaturated polyester resin.

### SUMMARY OF THE INVENTION

It is an object of the invention to provide treatments of surfaces of materials such as cement, concrete, mortar, floor screed, stone, marble or granite or the like materials in order to improve the tensile strength of the surfaces in order to reduce creation of dust (i.e. binding dust) during wear on surfaces of materials such as cement, concrete, mortar, floor screed, marble or granite or the like materials.

Further, it is an object to provide a treatment of materials such as cement, concrete, mortar, floor screed, marble or granite or the like materials which leaves an impression of a raw, untreated surface while protecting the surfaces form staining.

In addition, there is a need to provide a surface treatment of materials such as cement, concrete, mortar, floor screed, stone, marble or granite or the like materials which reduces the overall consumption of conventional coatings. In addition, there is a need to provide a surface treatment of such materials which provides improved adhesion of conventional top coatings while simultaneously providing a brighter surface on the treated surfaces of materials such as cement, concrete, mortar, floor screed, stone, marble or granite or the like materials.

There is also still a need for providing alternative compositions comprising recycled PVB and alternative uses of recycled PVB.

These objects are achieved with a composition for cement, concrete, mortar, floor screed, stone, marble or granite comprising 6-18% by weight of particles of polyvinyl butyral (PVB) dispersed in water, wherein the PVB contains 15-30% of plasticizer. The composition is thus especially suitable for applying to surfaces of buildings, e.g., floors, walls or ceilings or discrete articles made of cement, concrete, mortar, floor screed, stone, marble or granite or similar materials such as slabs, roof tiles or pavement slabs or statues or the like for obtaining improved staining resistance and/or improved resistance to wear, i.e. a dust binding effect. In addition, further effects obtained are e.g., a reduction of capillary water absorption into the materials; improved resistance to frost and de-icing salts; reduced chloride ion ingress and penetration in the concrete materials; reduced efflorescence (due to PH value >9.5); reduced dirt penetration into the pores of the materials; improved thermal insulation; the treated surface can be overcoated with other dispersion coatings or top coats. In addition, the cement, concrete, mortar, floor screed, stone, marble or granite treated with the composition demonstrates higher durability and resistance to e.g., wear than conventional silane treatments. Similarly the composition can substitute conventional hydrophobic impregnation compositions based on e.g., silanes or siloxanes, and provide alternative and non toxic compositions for hydrophobic impregnation.

In a preferred embodiment of the invention, the composition comprises 9-16% by weight, and more preferred 10-14% by weight of particles of polyvinyl butyral (PVB) in order to obtain a uniform layer in a single application and providing the optimum anti staining and/or dust binding effect of the composition while also providing reasonable costs. A particularly preferred embodiment of the composition is an aqueous dispersion having a PVB solids content of 12% by weight, a density of 1.01 kg/1, pH of approximately 9 and a Brookefield viscosity of 100-200 mPas at room temperature (20-25° C.).

The plasticizer contained in the PVB particles is believed to render it possible to create a stable aqueous dispersion of the PVB particles. Suitable plasticizers are plasticizers, other than phthalates, used conventionally used in PVB polymer compositions, such as tri- or tetraethylene glycol diesters of carboxylic acids, butylricinoleate, castor oil or blends of conventional PVB plasticizers.

In another embodiment of the invention, the PVB particles are made of recycled plasticized PVB in order to provide an alternative use of recycled PVB and at the same time reduce the costs per m² for treating the surfaces of cement, concrete, mortar or floor screed or the like materials. Recycled PVB is preferably obtained from working up non-shatterable glass laminates, e.g., automotive or architectural non-shatterable glass, and isolating the plasticized PVB used in the laminated glass.

The average size of the PVB particles is 1-100 μm, preferably 1-50 μm and more preferred 1-15 μm in order to ensure a stable aqueous dispersion and in order to ensure a uniform layer of PVB on the surfaces of cement, concrete, mortar or floor screed, or on stone, marble or granite. In addition, it is believed, that small particles of the PVB particles are able to enter the pores of the surfaces of cement, concrete, mortar or floor screed or the stone, marble or granite and provide an even further improved staining resistance and improved resistance to wear, i.e. also a dust binding effect.

The objects mentioned above are also achieved with a method for treating surfaces of cement, concrete, mortar, floor screed, stone, marble or granite comprising applying at least one layer of a composition comprising of 2-20% by weight of particles of plasticized polyvinyl butyral (PVB) dispersed in water in an amount of 100 g/m²-600 g/m² or corresponding to an amount of plasticized PVB of 2-120 g/m² This new and surprising method ensures that the surfaces exhibit improved resistance to wear, which results in reduced creation of dust during wear, i.e. a dust binding effect is achieved. In addition, the surface PVB layer applied protecting the surfaces from being stained, e.g., by oily substances. In addition, further effects obtained are e.g., a reduction of capillary water absorption into the materials; improved resistance to frost and de-icing salts; reduced chloride ion ingress and penetration in the concrete materials; reduced efflorescence (due to PH value>9.5); reduced dirt penetration into the pores of the materials; improved thermal insulation; can be overcoated with other dispersion coatings or top coats. In addition, the cement, concrete, mortar, floor screed, stone, marble or granite treated with the composition demonstrates higher durability and resistance to e.g., wear than conventional silane treatments. In a preferred embodiment of the method, the composition comprises 6-18% by weight or preferably 9-16% by weight, corresponding to an amount of plasticized PVB of 6-108 g/m² or preferably 9-96 g/m², and preferably 10-14% by weight of particles of plasticized polyvinyl butyral (PVB), corresponding to an amount of plasticized PVB of 10-84 g/m², in order to obtain a uniform layer in a single application and providing the optimum anti staining and/or dust binding effect of the composition while also providing reasonable costs. A particularly preferred embodiment of the method uses a dispersion having a PVB solids content of 12% by weight, a density of 1.01 kg/l, pH of approximately 9 and a Brookefield viscosity of 100-200 mPas at room temperature (20-25° C.).

Further, the application of a dilute aqueous PVB dispersion provides improved adhesion of conventional top coatings, such as epoxy, acrylic or polyurethane (PU) based resins while simultaneously providing a brighter surface on the treated surfaces of materials such as cement, concrete, mortar or floor screed or the like materials when compared to applying conventional coatings based on e.g., PU, acrylic or epoxy directly to the surfaces of cement, concrete, mortar, floor screed, stone, marble or granite or the like materials. In addition, when, the dilute PVB dispersion is applied as a primer prior to application of the conventional top coats, it results in a significant reduction of up to 50%-70% in overall consumption of the amount of top coat applied to obtain a uniform treated surface on such materials.

The aqueous PVB dispersion is applied to the surfaces by conventional methods, e.g., by brushes, rollers, rubber squeegees or by spraying.

In a preferred embodiment, the method comprises applying the PVB layer in an amount of 150 g/m²-500 g/m² corresponding to an amount of plasticized PVB of 3.5-100 g/m², or preferably 200 g/m²-400 g/m² of the aqueous PVB dispersion, corresponding to an amount of plasticized PVB of 4-80 g/m² or 20-48 g/m² of a composition containing 10-14% by weight of plasticized PVB, which provides a uniform layer of PVB a uniform layer on the surface in a single application while also providing the optimum anti staining and/or dust binding effect of the composition. In addition, it results in reasonably low costs. In order to reduce costs event further, the particles of plasticized PVB are made of recycled plasticized PVB.

The aqueous PVB dispersion composition may also be used as a primer for surfaces of cement, concrete, mortar, floor screed, stone, marble or granite or similar materials prior to applying one or more layers of a top coat composition, since it provides a unique pre-treated surface onto which conventional top layers adhere strongly. Suitable top coating compositions are conventional systems for surfaces of concrete etc. such as coatings based on epoxy, polyurethane (PU) or the like in order to obtain surfaces which are even more resistant to wear and staining. The thickness of the top coating can be reduced by up to 50-70% without compromising resistance to wear or anti-staining effects of the top coat compositions. S suitable topcoats are e.g., StoPur WV 150, a silk mat PU coating produced by STOCretec or StoPur WV 100, a shiny PU coating, also produced by STOCretec. Another unforeseen effect of using the aqueous PVB dispersion composition as a primer according to the present invention is that deterioration of the original colour of the surface of cement, concrete, mortar, floor screed, stone, marble or granite etc. is significantly reduced.

The present invention thus also relates to use of a composition comprising 2-20% by weight of particles of plasticized polyvinyl butyral (PVB) dispersed in water for increasing resistance to wear, binding dust and/or increasing adhesion of topcoats and/or increasing resistance to wear on surfaces of cement, concrete, mortar, floor screed, stone, marble or granite. The surface is preferably a part of a building, such as floors, walls or ceilings. In a preferred embodiment of the use, the composition comprises 2-20% by weight, and preferably 6-18% by weight or more preferred 10-14% by weight of particles of polyvinyl butyral (PVB) in order to obtain a uniform layer in a single application and providing the optimum anti staining and/or dust binding effect of the composition while also providing reasonable costs.

Similar effects are also obtained when the aqueous PVB dispersion is applied to discrete articles such as slabs, roof tiles or pavement slabs or statues or similar items made of cement, concrete, mortar or floor screed or stone such as marble, granite etc.

Roof tiles of concrete may e.g., be primed using the aqueous PVB dispersion prior to applying the conventional one or two layers of a coating based on acrylic resins. The consumption of the acrylic top coating can then be reduced with up to 50-70%.

The present invention will be described in detail using the figures in which

### BRIEF DESCRIPTION OF THE DRAWINGS

FIG. 1a shows an untreated reference slab marked T.J.ref of example 1 before subjected to wear,

FIG. 1b shows an untreated reference slab marked T.J.ref of example 1 after being subjected to wear,

FIG. 1c shows slab T.J.2 treated with the dilute aqueous PVB dispersion of example 1 1 before subjected to wear,

FIG. 1d shows slab T.J.2 treated with the dilute aqueous PVB dispersion of example 1 1 after being subjected to wear,

FIG. 1e shows slab T.J.3 treated with the dilute aqueous PVB dispersion of example 1 before subjected to wear,

FIG. 1f shows slab T.J.3 treated with the dilute aqueous PVB dispersion of example 1 after being subjected to wear,

FIG. 2a shows a slab of floor screed, treated with the aqueous PVB dispersion of example 2 on one half and with conventional PU coating on the other half,

FIG. 2b shows two slabs of a fibre based cement, the lower coated with the aqueous PVB dispersion used in example 1 and a conventional PU coating, the upper is coated with two layers of a conventional PU coating, and

FIGS. 3a-c shows an oil staining test on a concrete slab treated with the dilute aqueous PVB dispersion of example 1.

### DETAILED DESCRIPTION OF THE INVENTION

### EXAMPLE 1

Use of an aqueous dilute PVB dispersion as dust binder and/or a primer/pre-treatment agent was tested on concrete slabs using the test method according to DS/EN 13892-5:2003, Methods of test for screed materials—Part 5: Determination of wear resistance to rolling wheel of screed material for wearing layer.

### The Dispersion

An aqueous dispersion of PVB particles having an average particle size of 20 μm was prepared. The PVB particles are obtained from reclaimed PVB from Glass-PVB laminates, e.g., from disposed automobile windshields. The recycled PVB is shredded and comminuted into small particles having a mean particles size of 20 μm. The recycled PVB contains conventional plasticizers (other than phthalates) in an average amount of 20-25% by weight. The particulated PVB is dispersed in water resulting in a dispersion having a solids content of approximately 48% by weight, a density of 1.029kg/l, pH of approximately 9 and a brookefield viscosity of <600 mPas at room temperature (20-25 ° C.). This “concentrated” dispersion is diluted using 1 part PVB dispersion and 3 parts of water before application resulting in a dispersion having a PVB solids content of 12% by weight, a density of 1.01 kg/l, pH of approximately 9 and a Brookefield viscosity of 100-200 mPas at room temperature (20-25 ° C.).

### Concrete Slabs

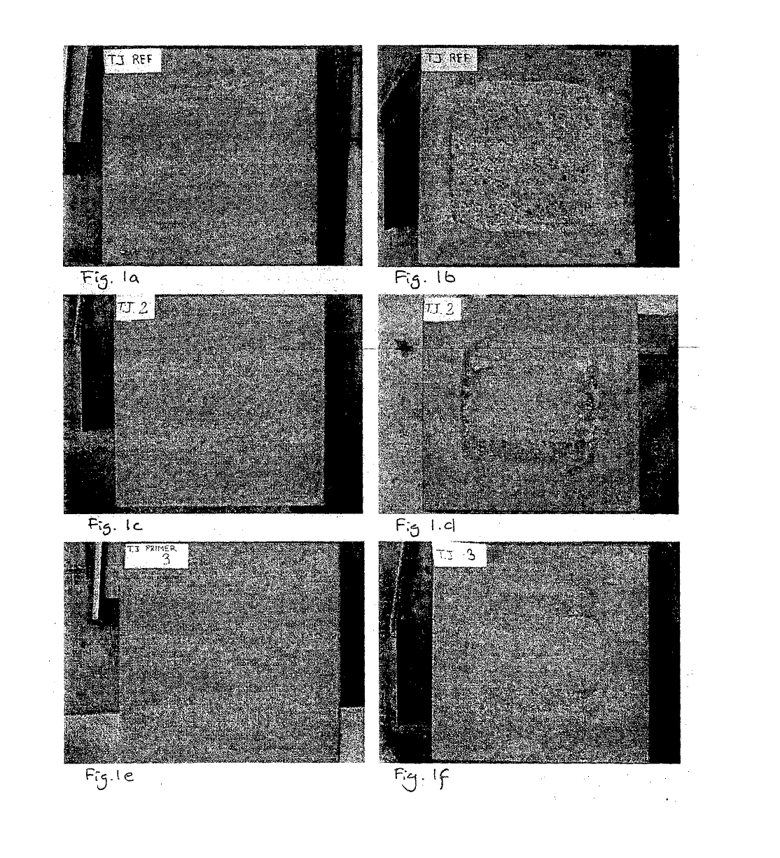

Three standard concrete slabs (size: 50 cm×50 cm) were used. The first concrete slab shown in FIG. 1a marked T.J.ref was an untreated reference slab. The slabs marked T.J. 2 (FIG. 1c) and T.J.3 (FIG. 1e) were treated with the dilute aqueous PVB dispersion with an amount as indicated in table 1 below.

The slabs were subjected to wear as described in DS/EN 13892-5:2003 Methods of test for screed materials—Part 5: Determination of wear resistance to rolling wheel of screed material for wearing layer. This European Standard specifies a method for determining the wear resistance to a heavily loaded rolling wheel on moulded mortar specimens made from cementitious screed material or synthetic resin screed material or optionally for other screed materials intended for wearing surface.

The slabs were subjected to the rolling wheel for 10,000 times intermittently during a week and the depth of wear (μm) was measured at 15 points on each slab. The mean depth of wear (μm) was calculated for each slab. In addition, the volume of material worn of during roller wear test (cm³) was collected and the total amount of material worn off was calculated for each slab. The results are listed in table 1. FIG. 1b shows the wear on the untreated reference slab (T.J. ref); FIG. 1d shows the wear on the treated slab marked T.J.2 and FIG. 1e shows the wear on the treated slab marked T.J.3.

The details of the wear tests are shown in the table:

TABLE 1
Results of wear in heavy roller wear test

| Test | Ref | T.J. 2 | T.J. 3 |
|---|---|---|---|
| Dispersion applied | 0 | 78 | 81 |
| in g | | | |
| Dispersion applied | 0 | 312 | 324 |
| in g/m² | | | |
| d: mean depth of | 1858 | 147 | 131 |
| wear (μm) | | | |
| RWA: volume of | 204 | 16 | 14 |
| material worn of | | | |
| during roller wear | | | |
| test (cm³) | | | |

### Conclusion Based on Test Results:

As can be seen in table 1 and FIGS. 1a-1e the concrete slabs treated with the aqueous PVB dispersion showed significantly less abrasion wear in the roller test when Compared to the untreated slabs and resulted in a very low volume of material worn off during the roller test. The results demonstrate that the dilute aqueous PVB dispersion is highly suitable for use as a primer and/or dust binder on concrete surfaces and similar surfaces subjected to daily wear.

### EXAMPLE 2

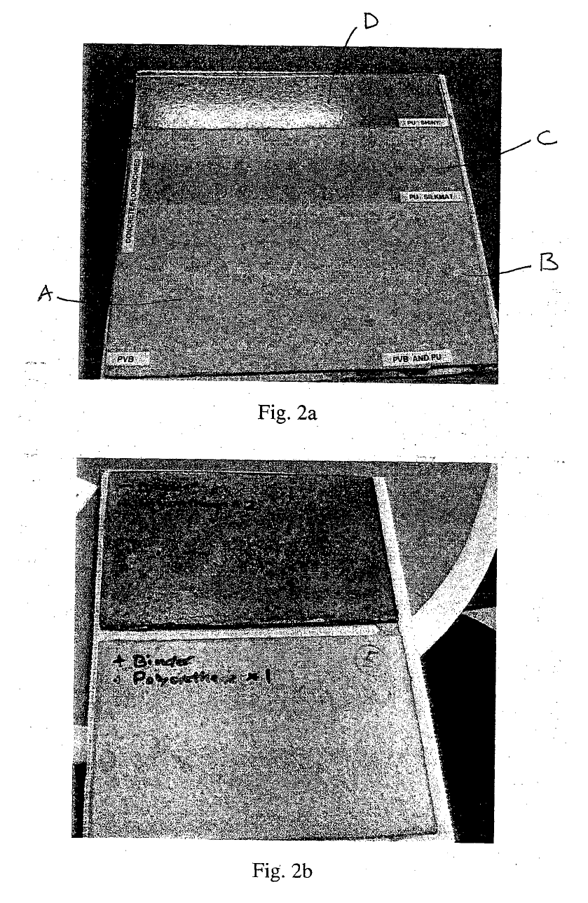

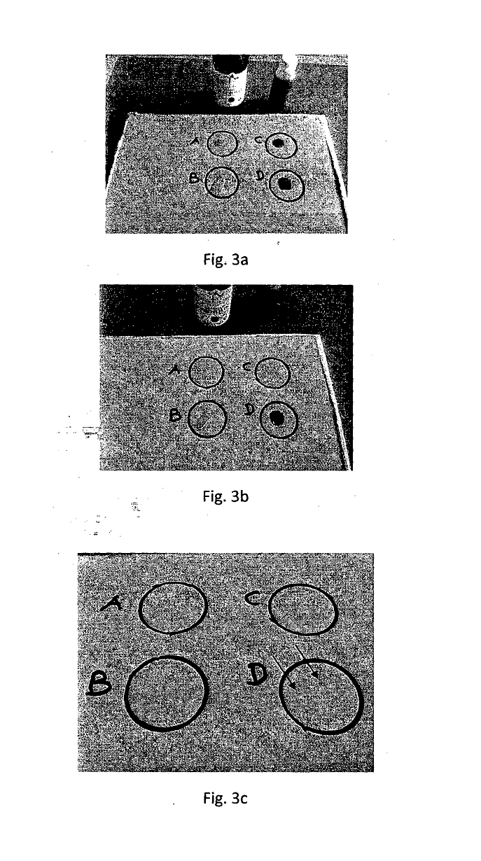

A slab of conventional floor screed was cast from an aluminate cement, StoCrete CS 730 marketed by STO. The aqueous PVB dispersion used in example 1 was applied by roller on one half of the dried slab, i.e. in the areas marked A and B in FIG. 2a in an amount of approximately 320 g/m². To the other half of the slab, i.e. in the areas marked C and D in FIG. 2a. a conventional silk mat PU coating, StoPur WV 150 marketed by StoCretec was applied by roller as a first coating layer. In the area marked D in FIG. 2a shiny PU coating (StoPur WV 100 marketed by StoCretec) was applied by roller on top of the silk mat PU coating resulting in a total of 200 g/m² PU coating. A layer of the silk mat PU coating was also applied on a part (field B of FIG. 2a) of the surface treated with the aqueous PVB dispersion in an amount of 70 g/m².

The area marked A (PVB only) looks similar almost identical to the surface of the floor screed before application of the coating.

The area marked B, treated with the dilute aqueous PVB dispersion and the silk mat PU top coat, demonstrates a significantly lighter colour compared to areas C and D.

FIG. 2b shows two slabs cast of fibre cement StoCrete CS 735 marketed by STO. The upper slab was coated with two layers of a conventional shiny PU coating (StoPur WV 100 marketed by StoCretec) which was applied by roller in a total amount of 350 g/m². The aqueous PVB dispersion used in example 1 and above was applied by roller to the lower slab in an amount of approximately 320 g/m² followed by a single layer of the conventional shiny PU coating used on the upper slab in an amount of 120 g/m². Both slabs demonstrated uniformly coated surfaces. The lower slab (treated with the dilute aqueous PVB dispersion and the PU top coat), demonstrates a significantly lighter colour compared to the upper slab (treated with two layers of PU coating) and the consumption of PU top coat is reduced by 65% while a satisfactory surface coating was obtained.

In conclusion, when, the dilute PVB dispersion is applied as a primer prior to application of the conventional top coats, it results in a significant reduction of up to 50%-70% in overall consumption of the amount of top coat applied to obtain a uniform treated surface on different materials such as floor creed and fibre cement. Further, it is concluded, that this effect will also be seen on similar building materials such as cement, concrete, mortar, floor screed, stone, marble or granite or similar materials.

### EXAMPLE 3

A concrete slab (50×50 cm) treated with the aqueous PVB dispersion used in example 1 was tested for oil staining.

The aqueous PVB dispersion used in example 1 was applied by roller on the concrete slab, in an amount of approximately 250-300 g/m².

In the areas A and B, a conventional food grade rape seed oil (yellow; sold under the name: “Egeskov koldpresset rapsolie”) was applied to the concrete surface, and in the areas C and D a conventional two-stroke-engine oil (Blue; unknown brand). After 30 minutes the oil in the areas A and C was wiped of with a paper towel, and after 1 hour the areas B and D the oil in the areas A and C was wiped of with a paper towel. All areas show no staining from the oil, except in area D where two small pinholes (marked by arrows) were stained blue by the engine oil.

The pinholes indicate areas where the coating with the PVB dispersion on the concrete slab is missing. The oils will absorb into the surface of an untreated concrete slab in a similar way as in the pinholes and stain the concrete surface. This example clearly shows that the treatment with the aqueous dispersion of plasticized PVB result in anti-staining effect on the surface of concrete materials and similar materials such as cement, mortar, floor screed, etc.

1. A dust binder and/or primer composition for cement, concrete, mortar, floor screed, stone, marble or granite comprising 6-18% by weight of particles of polyvinyl butyral (PVB) dispersed in water, wherein the PVB contains 15-30% of plasticizer.

2. The dust binder and/or primer composition according to claim 1, wherein the PVB particles are made of recycled plasticized PVB.

3. The dust binder and/or primer composition according to claim 1, wherein the particle size is 1-100 μm, 1-15 μm.

4. The dust binder and/or primer composition according to claim 1, comprising 9-16% by weight.

5. A method for treating surfaces of cement, concrete, mortar, floor screed, stone, marble or granite comprising the steps of applying at least one layer of a composition comprising of 2-20% by weight of particles of plasticized polyvinyl butyral (PVB) dispersed in water in an amount of 100 g/m²-600 g/m².

6. The method according to claim 5, wherein the composition comprises 6-18% by weight.

7. The method according to claim 5, comprising applying the layer in an amount of 150 g/m²-500 g/m².

8. The method according to claim 5, wherein the particles of plasticized PVB are made of recycled plasticized PVB.

9. The method according to claim 5, comprising applying at least one layer of a top coat composition.

10. A method of binding of dust and/or increasing adhesion of topcoats and/or increasing resistance to wear on surfaces of cement, concrete, mortar, floor screed, stone, marble or granite comprising applying a composition comprising 2-20% by weight of particles of plasticized polyvinyl butyral (PVB) dispersed in water.

11. The method according to claim 10, wherein the surface is a part of a building.

12. The method according to claim 10, wherein the surface to be treated is on a discrete article from the group comprised of slabs, roof tiles, pavement slabs or statues.

13. The method according to claim 10, wherein the PVB particles are made of recycled plasticized PVB.

14. The dust binder and/or primer composition according to claim 1, wherein the particle size is 1-15 μm.

15. The dust binder and/or primer composition according to claim 1, comprising 10-14% by weight of the particles of polyvinyl butyral (PVB).

16. The method according to claim 5, wherein the composition comprises 10-14% by weight of particles of plasticized polyvinyl butyral (PVB).
